(19) United States
(12) Patent Application Publication
(10) Pub. No.: US 2009/0037661 A1
(43) Pub. Date: Feb. 5, 2009

(54) Cache mechanism for managing transient data

(75) Inventor: Mark Fairhurst, Chorlton (GB)

Correspondence Address: Gerald W. Maliszewski, P.O.Box 270829, San Diego, CA, 92198-2829, US

(73) Assignee: Applied Micro Circuits Corporation, San Diego, CA (US)

(21) Appl. No.: 11/888,922

(22) Filed: Aug. 4, 2007

(51) Int. Cl. G06F 13/14

(52) U.S. Cl. 711/133; 711/E12.002

(57) ABSTRACT

A system and method are provided for managing transient data in cache memory. The method accepts a segment of data and stores the segment in a cache line. In response to accepting a read-invalidate command for the cache line, the segment is both read from the cache line and the cache line made invalid. If, prior to accepting the read-invalidate command, the segment in the cache line is modified, the modified segment is not stored in a backup storage memory as a result of subsequently accepting the read-invalidate command. In one aspect, the segment is initially identified as transient data, and the read-invalidate command is used in response to identifying the segment as transient data.

### BACKGROUND OF THE INVENTION

1. Field of the Invention

This invention generally relates to digital memory devices and, more particularly, to a system and method for using a time-based process to control the replacement of data in a cache memory.

2. Description of the Related Art

Small CPU-related memories can be made to perform faster than larger main memories. Most CPUs use one or more caches, and modern general-purpose CPUs inside personal computers may have as many as half a dozen, each specialized to a different part of the problem of executing programs.

A cache is a temporary collection of digital data duplicating original values stored elsewhere. Typically, the original data is expensive to fetch, due to a slow memory access time, or to compute, relative to the cost of reading the cache. Thus, cache is a temporary storage area where frequently accessed data can be stored for rapid access. Once the data is stored in the cache, the cached copy can be quickly accessed, rather than re-fetching or recomputing the original data, so that the average access time is lower.

Caches have proven to be extremely effective in many areas of computing because access patterns in typical computer applications have locality of reference. A CPU and hard drive frequently use a cache, as do web browsers and web servers.

FIG. 1 is a diagram of a cache memory associated with a CPU (prior art). A cache is made up of a pool of entries. Each entry has a datum or segment of data which is a copy of a segment in the backing store. Each entry also has a tag, which specifies the identity of the segment in the backing store of which the entry is a copy.

When the cache client, such as a CPU, web browser, operating system wishes to access a data segment in the backing store, it first checks the cache. If an entry can be found with a tag matching that of the desired segment, the segment in cache is accessed instead. This situation is known as a cache hit. So for example, a web browser program might check its local cache on disk to see if it has a local copy of the contents of a web page at a particular URL. In this example, the URL is the tag, and the contents of the web page are the segment. Alternately, when the cache is consulted and found not to contain a segment with the desired tag, a cache miss results. The segment fetched from the backing store during miss handling is usually inserted into the cache, ready for the next access.

If the cache has limited storage, it may have to eject some entries to make room for other entries. The heuristic used to select the entry to eject is known as the replacement policy. One popular replacement policy, least recently used (LRU), replaces the least recently used entry. More efficient caches compute use frequency against the size of the stored contents, as well as the latencies and throughputs for both the cache and the backing store. While this system works well for larger amounts of data, long latencies, and slow throughputs, such as experienced with a hard drive and the Internet, it's not efficient to use these algorithms for cached main memory (RAM).

When a data segment is written into cache, it is typically, at some point, written to the backing store as well. The timing of this write is controlled by what is known as the write policy. In a write-through cache, every write to the cache causes a write to the backing store. Alternatively, in a write-back cache, writes are not immediately mirrored to the store. Instead, the cache tracks which of its locations (cache lines) have been written over. The segments in these “dirty” cache lines locations are written back to the backing store when those data segments are replaced with a new segment. For this reason, a miss in a write-back cache will often require two memory accesses to service: one to retrieve the needed segment, and one to write replaced data from the cache to the store.

Data write-back may be triggered by a client that makes changes to a segment in the cache, and explicitly notifies the cache to write back the modified segment into the backup store. No-write allocation is a cache policy where only processor reads are cached, thus avoiding the need for write-back or write-through when the old value of the data segment is absent from the cache prior to the write.

The data in the backing store may be changed by entities other than the cache, in which case the copy in the cache may become out-of-date or stale. Alternatively, when the client updates the data in the cache, copies of that data in other caches will become stale. Communication protocols between the cache managers which keep the data consistent are known as coherency protocols.

CPU caches are generally managed entirely by hardware. Other caches are managed by a variety of software. The cache of disk sectors in main memory is usually managed by the operating system kernel or file system. The BIND DNS daemon caches a mapping of domain names to IP addresses, as does a resolver library.

Write-through operations are common when operating over unreliable networks (like an Ethernet LAN), because of the enormous complexity of the coherency protocol required between multiple write-back caches when communication is unreliable. For instance, web page caches and client-side network file system caches (like those in NFS or SMB) are typically read-only or write-through, specifically to keep the network protocol simple and reliable.

A cache of recently visited web pages can be managed by a web browser. Some browsers are configured to use an external proxy web cache, a server program through which all web requests are routed so that it can cache frequently accessed pages for everyone in an organization. Many internet service providers use proxy caches to save bandwidth on frequently-accessed web pages.

Search engines also frequently make web pages they have indexed available from their cache. For example, a “Cached” link next to each search result may be provided. This is useful when web pages are temporarily inaccessible from a web server.

Another type of caching is storing computed results that will likely be needed again. An example of this type of caching is ccache, a program that caches the output of the compilation to speed up the second-time compilation.

In contrast to cache, a buffer is a temporary storage location where a large block of data is assembled or disassembled. This large block of data may be necessary for interacting with a storage device that requires large blocks of data, or when data must be delivered in a different order than that in which it is produced, or when the delivery of small blocks is inefficient. The benefit is present even if the buffered data are written to the buffer only once and read from the buffer only once. A cache, on the other hand, is useful in situations where data is read from the cache more often than they are written there. The purpose of cache is to reduce accesses to the underlying storage.

As noted above, caching structures are often used in computer systems dealing with persistent data. The processor loads the data into the cache at the start of, and during processing. Access latencies are improved during processing as the cache provides a store to hold the data structures closer to the processor than the main memory. As the data is deemed persistent, any modifications to the data structures are written to the main backing store upon completion of processing or cache line replacement.

Transient data differs from persistent in that it has a limited duration in which the data is valid. Once the data has been accessed for the final time it is then inactive, and is not accessed further at a later time. Packet payload is an example of transient data. The packet arrives from a line interface, is accessed throughout processing (e.g. classification and de/encryption) and is then transmitted out of the system. Once valid transmission has been achieved, the packet data is not accessed again. In contrast, flow context data structures are persistent. The processing of a packet may result in the modification of the flow context (e.g. statistics counters). However once the packet has been transmitted, the flow data structure must be maintained for future use, i.e., for packet processing of any future packets within the flow.

Write invalidate commands exist to allow new data to invalidate any old modified data still resident in the cache hierarchy. This process assists in the reuse of address locations, but it is not optimized for transient data (i.e., data can be replaced in the period from final read to write invalidate command on reuse of the address). Conventionally, transient data is either located within the main (off chip) data store and/or within on-chip buffers or queues. The management of these on-chip resources can be complicated with the sizing of on-chip storage. It is difficult to determine and map the different addresses required between the on-chip and off-chip stores. Cache “stashing” techniques are widely deployed for transient data that allow the locking of lines within the cache. This locking process however, does not change the process of writing modified lines to the backing store, even when the data will not be accessed in the future.

It would be advantageous if the redundant operation of writing modified transient data to a backing store from cache could be eliminated.

It would be advantageous if transient data could be made invalid in cache without the need for a separate invalidate command.

### SUMMARY OF THE INVENTION

This disclosure describes a cache structure optimized for the storage of transient data, with application in network or signal processing. The disclosed cache system augments conventional cache design with a process for cache accesses that invalidate line(s) within the cache, without writing modified lines to backing store A read-invalidate command is provided that reads the data from the cache, if there is a cache hit, and invalidates the line(s) without writing to backing store.

Accordingly, a method is provided for managing transient data in cache memory. The method accepts a segment of data and stores the segment in a cache line. In response to accepting a read-invalidate command for the cache line, the segment is both read from the cache line and the cache line made invalid. If, prior to accepting the read-invalidate command, the segment in the cache line is modified, the modified segment is not stored in a backup storage memory as a result of subsequently accepting the read-invalidate command.

In one aspect, the segment is initially identified as transient data, and the read-invalidate command is used in response to identifying the segment as transient data. The segment may be identified as transient by cross-referencing input ports with transient data sources, and identifying the input port supplying the segment. Alternately, the segment can be identified as transient data by reading persistence fields included in the segment, or in a communication associated with the segment. For example, the transient data segment may be a packet payload.

Additional details of the above-described method and a transient data cache memory management system are provided below.

### BRIEF DESCRIPTION OF THE DRAWINGS

FIG. 1 is a diagram of a cache memory associated with a CPU (prior art).

FIG. 2 is a schematic block diagram of a transient data cache memory management system.

FIG. 3 is a flowchart illustrating a method for managing transient data in cache memory.

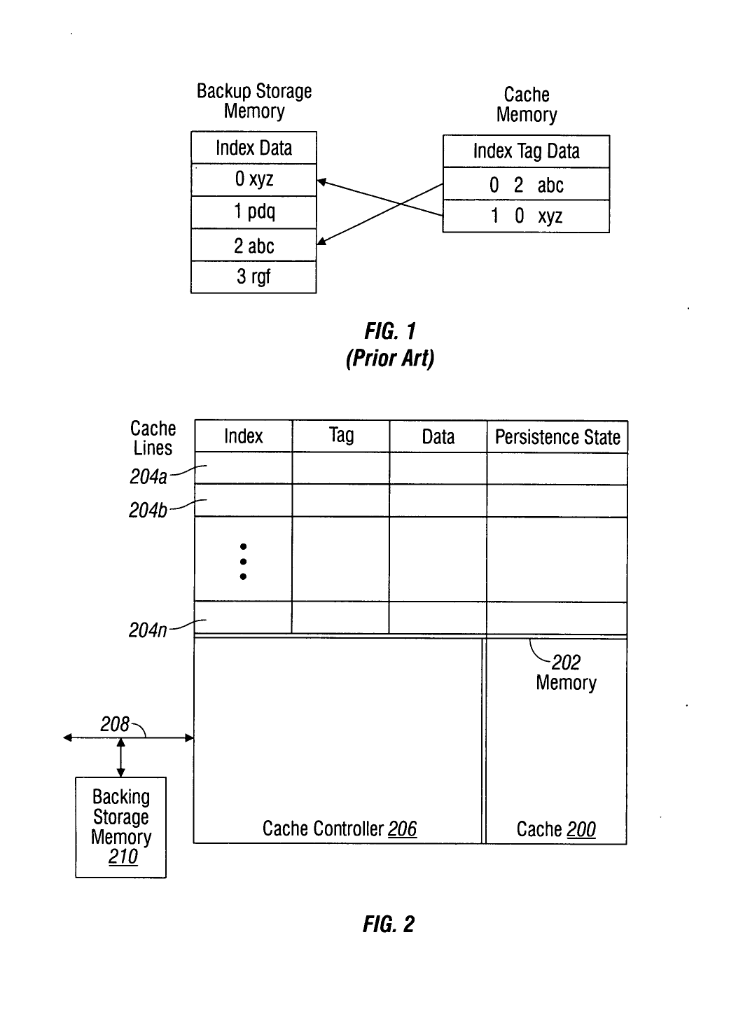

### DETAILED DESCRIPTION

Various embodiments are now described with reference to the drawings. In the following description, for purposes of explanation, numerous specific details are set forth in order to provide a thorough understanding of one or more aspects. It may be evident, however, that such embodiment(s) may be practiced without these specific details. In other instances, well-known structures and devices are shown in block diagram form in order to facilitate describing these embodiments.

As used in this application, the terms “processor”, “processing device”, “component,” “module,” “system,” and the like are intended to refer to a computer-related entity, either hardware, firmware, a combination of hardware and software, software, or software in execution. For example, a component may be, but is not limited to being, a process running on a processor, generation, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Various embodiments will be presented in terms of systems that may include a number of components, modules, and the like. It is to be understood and appreciated that the various systems may include additional components, modules, etc. and/or may not include all of the components, modules etc. discussed in connection with the figures. A combination of these approaches may also be used.

The various illustrative logical blocks, modules, and circuits that have been described may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in the node, or elsewhere. In the alternative, the processor and the storage medium may reside as discrete components in the node, or elsewhere in an access network.

FIG. 2 is a schematic block diagram of a transient data cache memory management system. The system 200 comprises a memory 202 including a plurality of cache lines for storing segments of data. Lines 204a through 204n are shown, where n is not limited to any particular value. Each cache line 204 may cross-reference the data segment to an index (backup store address) and a tag. For simplicity, the data segment is also cross-referenced to the persistence state (i.e., is the segment persistent or transient data). However, the persistence state for a segment need not necessarily be stored in its corresponding cache line, and need not even be stored in cache memory 202.

A cache controller 206 accepts data segments on line 208 to be written into a cache line 204. The cache controller 206 also reads a resident segment from a cache line and then makes that particular cache line invalid in response to receiving a read-invalidate command on line 208.

In one aspect, the cache controller 206 accepts the read-invalidate command in response to the segment being identified as transient data. The segment identification process may occur at a device (not shown) external to the cache system 200, and the identification information is passed in a communication to the cache system. Alternately, the cache system 200 simply receives read-invalidate commands as a result of this external identification process. The identification may occur as a result of determining the port supplying the data segment, as a particular port may be associated with transient data. Alternately, the identification can be made by examination of a transient/persistent data overhead field associated with the segment. One example of a transient data segment is a packet payload.

If the (tagged) segment is resident in the cache line, the cache controller 206 returns a cache hit indication on line 208 in response the segment being read. If the segment is not resident in the cache line, the cache controller 206 returns a cache miss indication.

In one aspect, the cache controller 206 accepts a read command for the segment resident in cache line 204, prior to accepting the read-invalidate command. The cache controller 206 accepts a modified segment, and stores the modified segment in the cache line. In response to the subsequently accepted the read-invalidate command, the cache controller 206 fails to initiate an operation for storing the modified segment in a connected backup storage memory 210.

Elements of the cache controller may be enabled in hardware, stored in memory as software commands executed by a processor, or be enabled as a combination of hardware and software elements.

### Functional Description

The above-described cache management system eliminates redundant writes to main backing store for transient data, and has application in network or signal processing. The throughput and access latencies of the main backing store are often a critical item in performance. Therefore, removal of any unnecessary accesses has a beneficial impact on performance.

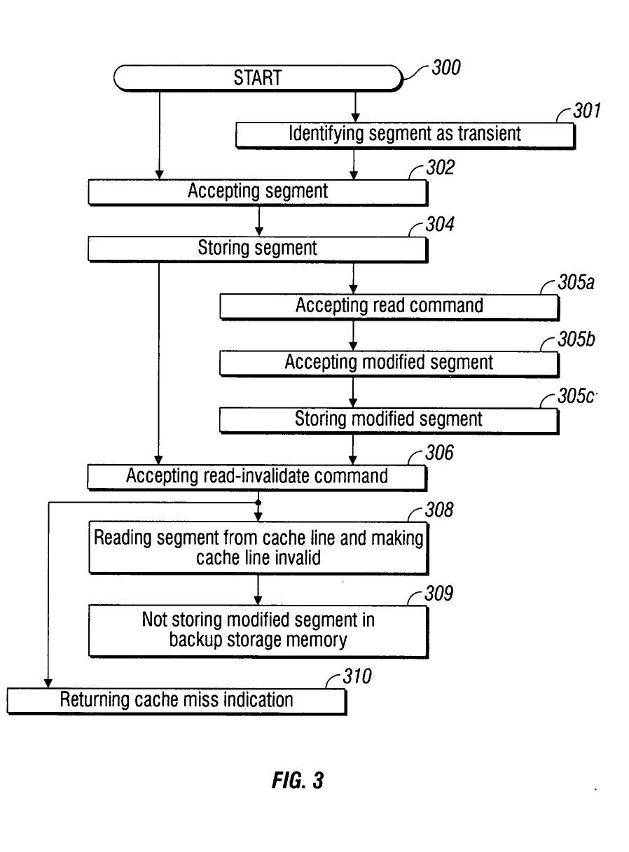

FIG. 3 is a flowchart illustrating a method for managing transient data in cache memory. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 300.

Step 302 accepts a segment of data. Step 304 stores (writes) the segment in a cache line. Step 306 accepts a read-invalidate command for the cache line. In response to the read-invalidate command, Step 308 both reads the segment from the cache line, and makes the cache line invalid. In one aspect, Step 308 returns a cache hit indication in response to reading the segment from the cache line. Alternately, in response to an addressed (tagged) segment not being resident in the cache line, Step 310 returns a cache miss indication.

In one aspect, prior to accepting the read-invalidate command, Step 305a accepts a read command for the segment resident in the cache line. Step 305b accepts a modified segment, and Step 305c stores the modified segment in the cache line. Then, in response to subsequently accepting the read-invalidate command in Step 306, Step 309 does not store the modified segment in a backup storage memory.

In a different aspect, Step 301 identifies the segment as transient data. Then, Step 306 accepts the read-invalidate command as a result of the segment being identified as transient data. Alternately but not shown, the segment may be identified after it is accepted and written into cache. For example, Step 301 may identify the segment as transient data by cross-referencing input ports with transient data sources, and identifying the input port supplying the segment. Alternately, Step 301 may identifying the segment as transient data by reading persistence fields included in the segment, or in a communication associated with the segment. In one aspect, Step 301 identifies a packet payload in the segment.

A system and method for the management of transient data in a cache have been provided. Some explicit details and examples have been given to illustrate the invention. However, the invention is not limited to just these examples. Other variations and embodiments of the invention will occur to those skilled in the art.

We claim:

1. A method for managing transient data in cache memory, the method comprising:
accepting a segment of data;
storing the segment in a cache line;
accepting a read-invalidate command for the cache line;
in response to the read-invalidate command:
reading the segment from the cache line; and,
making the cache line invalid.

2. The method of claim 1 wherein reading the segment from the cache line includes returning a cache hit indication.

3. The method of claim 1 further comprising:
in response to the segment not being resident in the cache line, returning a cache miss indication.

4. The method of claim 1 further comprising:
prior to accepting the read-invalidate command, accepting a read command for the segment resident in the cache line;
accepting a modified segment;
storing the modified segment in the cache line; and,
in response to subsequently accepting the read-invalidate command, not storing the modified segment in a backup storage memory.

5. The method of claim 1 further comprising:
identifying the segment as transient data; and,
wherein accepting the read-invalidate command includes accepting the read-invalidate command in response to identifying the segment as transient data.

6. The method of claim 5 wherein identifying the segment as transient data includes:
cross-referencing input ports with transient data sources; and,
identifying the input port supplying the segment.

7. The method of claim 5 wherein identifying the segment as transient data includes reading persistence fields included in the segment.

8. The method of claim 5 wherein identifying the segment as transient data includes identifying a packet payload in the segment.

9. A transient data cache memory management system, the system comprising:
a memory including a plurality of cache lines for storing segments of data; and,
a cache controller to read resident segments and make a cache line invalid in response to receiving a read-invalidate command.

10. The system of claim 9 wherein the cache controller returns a cache hit indication in response the segment being read.

11. The system of claim 9 wherein the cache controller returns a cache miss indication in response to the segment not being resident in the cache line.

12. The system of claim 9 wherein the cache controller accepts a read command for the segment resident in the cache line, prior to accepting the read-invalidate command, the cache controller accepting a modified segment and storing the modified the segment in the cache line; and,
wherein the cache controller, in response to the subsequently accepted the read-invalidate command, fails to initiate an operation for storing the modified segment in a connected backup storage memory.

13. The system of claim 9 wherein the cache controller accepts the read-invalidate command in response to the segment being identified as transient data.
